(19) United States
(12) Patent Application Publication
(10) Pub. No.: US 2026/0013639 A1
(43) Pub. Date: Jan. 15, 2026

(54) FURNITURE APPARATUS WITH CONCEALMENT CHAMBER

(71) Applicant: Micah Daboub, Santa Fe, NM (US)

(72) Inventor: Micah Daboub, Santa Fe, NM (US)

(21) Appl. No.: 18/767,956

(22) Filed: Jul. 9, 2024

(51) Int. Cl. A47C 15/00; A47B 9/00; A47B 13/08; A47B 85/04; A61H 19/00

(52) U.S. Cl. CPC A47C 15/008; A47B 9/00; A47B 13/088; A47B 85/04; A61H 19/50

(57) ABSTRACT

A furniture apparatus can include a group of height adjustable legs supporting a hinged tabletop comprising two or more foldable sections including a first foldable section and a second foldable section. The furniture apparatus can further include one or more devices, wherein the first foldable section and the second foldable section can open upward from a locked and closed position to reveal a gap within which the one or more utility devices can be installed and concealed when the foldable sections are in a closed position and the hinged tabletop rests in a flat horizontal position.

### TECHNICAL FIELD

Embodiments are related to the field of furniture design and construction, particularly to multi-functional furniture apparatuses. More specifically, embodiments relate to furniture equipped with a concealment chamber integrated within its structure. Embodiments further relate to a concealment chamber designed to securely store a utility apparatus, while maintaining the aesthetic appeal and functionality of the furniture while providing an additional layer of utility and security. Embodiments further relate to discreet storage solutions for utility devices stored and maintained within, for example, common furniture.

### BACKGROUND

In contemporary household environments, there is a growing need for innovative storage solutions that not only provide practical functionality but also complement the aesthetic appeal of interior design. With the increasing presence of various utility devices in the home, such as electronic equipment, personal security systems, and other functional apparatuses, the challenge of effectively organizing and concealing these items has become more pronounced. Traditional storage methods often involve bulky cabinets or visible containers, which can detract from the overall aesthetic of a living space.

Furthermore, there is a need for discreet storage solutions. Traditional storage methods, such as visible cabinets or drawers, can compromise the discretion that users often desire, leading to potential discomfort or embarrassment if discovered by guests or other household members. A need thus exists for an improved discreet storage solution.

One of the problems with current discreet storage solutions involves their often limited capacity and inflexibility. Many designs fail to accommodate a wide range of items, particularly those with irregular shapes or larger sizes. This limitation forces users to either leave such items exposed or store them in less convenient locations, neither of which is ideal.

Another significant issue is the accessibility of stored items. Discreet storage solutions can sometimes prioritize concealment over ease of access, resulting in inconvenient or cumbersome retrieval processes. This can be especially problematic in emergency situations where quick access to stored items is crucial, such as accessing personal security devices or emergency supplies.

Additionally, the aesthetic integration of storage solutions within modern interior design remains a challenge. Many existing solutions are either conspicuous or fail to blend seamlessly with various decor styles, thus failing to meet the growing consumer demand for stylish yet functional home furnishings. The visual impact of storage solutions is a critical factor for many users, who seek to maintain a harmonious and uncluttered appearance in their living spaces.

Security is another area where current discreet storage solutions often fall short. While they may hide items from plain view, they do not always provide sufficient protection against theft or unauthorized access. This is particularly concerning for storing valuable or sensitive items such as jewelry, important documents, or personal electronics.

Finally, traditional storage solutions may not be adaptable to the rapidly changing technological landscape. With the advent of smart homes and the increasing integration of digital devices, there is a pressing need for storage solutions that can accommodate new and evolving technologies. This includes considerations for cable management, ventilation for electronic devices, and the integration of charging capabilities.

While traditional storage solutions offer some level of functionality, they often fall short in terms of capacity, accessibility, aesthetic integration, security, and adaptability. Therefore, there is a clear and pressing need for improved discreet storage solutions that address these deficiencies, providing users with practical, secure, and aesthetically pleasing options for organizing and concealing their household items.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, one aspect of the embodiments to provide for the design and construction of improved multi-functional furniture apparatuses.

It is another aspect of the embodiments to provide for furniture equipped with a concealment chamber integrated within its structure.

It is a further aspect of the embodiments to provide for a concealment chamber designed to securely store a utility apparatus, while maintaining the aesthetic appeal and functionality of the furniture while providing an additional layer of utility and security.

It also an aspect of the embodiments to provide for discreet storage solutions for utility devices within common household furniture, enhancing both the practical and aesthetic aspects of interior design.

The aforementioned aspects and other objectives and advantages can now be achieved as described herein. In an embodiment, a furniture apparatus can be implemented, which can include a group of height adjustable legs supporting a hinged tabletop comprising at least two foldable sections including a first foldable section and a second foldable section, and a group of utility devices, wherein the first foldable section and the second foldable section open upward from a locked and closed position to reveal a gap within which the group of utility devices can be installed and concealed when the at least two foldable sections are in a closed position and the hinged tabletop rests in a flat horizontal position.

In an embodiment, the furniture apparatus can further include one or more locks can secure the hinged tabletop.

In an embodiment, at least one lock can secure the hinged tabletop when the foldable sections are closed and folded flat to form the hinged tabletop and conceal the group of utility devices.

In an embodiment, the group of utility devices can include a first utility device connected to a second utility device by a rotatable hinge portion.

In an embodiment, the group of utility devices can include a first utility device connected to a second utility device by a rotatable hinge portion that allows the first utility device to rotate upward and lock to a position ninety degrees with respect to the second utility device, which remains in a horizontal position.

In an embodiment, the first utility device can be a pillory/stock and the second utility device can comprise one or more seats including a smaller seat connected to a larger seat.

In an embodiment, each of the aforementioned seats can be configured with and/or comprise a group of slats with gaps respectively located between each slat.

In an embodiment, each leg among the group of height adjustable legs can be raised or lowered to assist in increasing or lowering a height of the furniture apparatus.

In an embodiment, one or more magnetic locking pins can be respectively associated with the group of height adjustable legs.

In an embodiment, the furniture apparatus can include an adjustable restraint apparatus comprising the group of utility devices, wherein the adjustable restraint apparatus can be concealed beneath the hinged tabletop when the two (or more) foldable sections are located in a closed position to form the hinged tabletop.

An embodiment of the furniture apparatus can be configured as a coffee table or other type of table (e.g., living room table) that can include the hinged tabletop, wherein when the foldable sections are open, the adjustable restraint apparatus is revealed.

In an embodiment, the adjustable restraint device can be configured as a BDSM bondage device.

In an embodiment, the furniture apparatus can include a group of height adjustable legs supporting a hinged tabletop comprising at least two foldable sections including a first foldable section and a second foldable section; a group of utility devices, wherein the first foldable section and the second foldable section open upward from a locked and closed position to reveal a gap within which the group of utility devices are installed and concealed when the at least two foldable sections are in a closed position and the hinged tabletop rests in a flat horizontal position; and at least one lock that secures the hinged tabletop when the at least two foldable sections are closed and folded flat to form the hinged tabletop and conceal the group of utility devices.

In an embodiment, a furniture apparatus can include a group of height adjustable legs supporting a hinged tabletop comprising at least two foldable sections including a first foldable section and a second foldable section; at least one utility device, wherein the first foldable section and the second foldable section open upward from a locked and closed position to reveal a gap within which the group of utility devices are installed and concealed when the at least two foldable sections are in a closed position and the hinged tabletop rests in a flat horizontal position; and at least one lock that secures the hinged tabletop when the at least two foldable sections are closed and folded flat to form the hinged tabletop and conceal the at least one utility device, wherein the at least one utility device includes a first utility device connected to a second utility device by a rotatable hinge portion that allows the first utility device to rotate upward and lock to a position ninety degrees with respect to the second utility device, which remains in a horizontal position.

### BRIEF DESCRIPTION OF THE DRAWINGS

The accompanying figures, in which like reference numerals refer to identical or functionally similar elements throughout the separate views and which are incorporated in and form a part of the specification, further illustrate the present invention and, together with the detailed description of the invention, serve to explain the principles of the present invention.

FIG. 1 illustrates a top perspective view of a furniture apparatus having a hinged tabletop and two foldable sections in a flat horizontal position, in accordance with an embodiment;

FIG. 2 illustrates a side perspective view of the furniture apparatus shown in FIG. 1 with the two foldable sections in an open position revealing a gap therein, in accordance with an embodiment;

FIG. 3 illustrates another view of the furniture apparatus with one or more utility devices providing a pillory-like structure in an upward position, in accordance with an embodiment;

FIG. 4 illustrates a front view of the furniture apparatus with the utility device in an open and locked position, in accordance with an embodiment;

FIG. 5 illustrates a locking mechanism, which can be incorporated into the furniture apparatus, in accordance with an embodiment;

FIG. 6 illustrates a side perspective view of the locking mechanism, in accordance with an embodiment;

FIG. 7 illustrates a height adjustable leg, which may be implemented in accordance with an embodiment;

FIG. 8 illustrates a view of individual components of the height adjustable leg, which may be implemented in accordance with an embodiment;

FIG. 9 illustrates a front view of the furniture apparatus with the utility device in an open position, in accordance with an embodiment;

FIG. 10 illustrates a back view of the furniture apparatus with the utility device in an open position, in accordance with an embodiment; and

FIG. 11 illustrates a view of the furniture apparatus with a series of holes located at each corner, which can be used as tie downs for transportation and/or storage of the furniture apparatus, in accordance with an embodiment.

In the description and figures herein, identical references numerals can refer to like or identical parts or elements.

### DETAILED DESCRIPTION

The particular values and configurations discussed in these non-limiting examples can be varied and are cited merely to illustrate one or more embodiments and are not intended to limit the scope thereof.

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The following detailed description is, therefore, not intended to be interpreted in a limiting sense.

Throughout the specification and claims, terms may have nuanced meanings suggested or implied in context beyond an explicitly stated meaning. Likewise, phrases such as “in one embodiment” or “in an example embodiment” and variations thereof as utilized herein do not necessarily refer to the same embodiment and the phrase “in another embodiment” or “in another example embodiment” and variations thereof as utilized herein may or may not necessarily refer to a different embodiment. It is intended, for example, that claimed subject matter include combinations of example embodiments in whole or in part.

In general, terminology may be understood, at least in part, from usage in context. For example, terms such as “and,” “or,” or “and/or” as used herein may include a variety of meanings that may depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms such as “a,” “an,” or “the”, again, may be understood to convey a singular usage or to convey a plural usage, depending at least in part upon context.

In addition, the term “based on” may be understood as not necessarily intended to convey an exclusive set of factors and may, instead, allow for existence of additional factors not necessarily expressly described, again, depending at least in part on context. Furthermore, the term “at least one” as utilized herein can refer to “one or more”. For example, “at least one widget” may refer to “one or more widgets” and “at least two widgets” may refer to “two or more widgets” and so on.

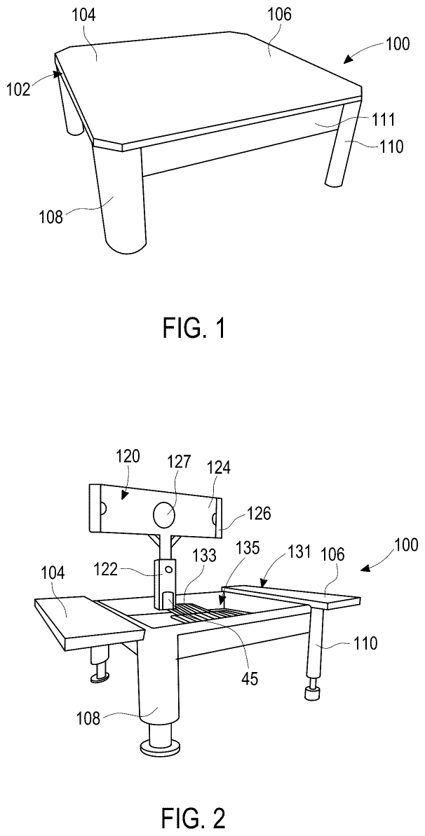

FIG. 1 illustrates a top perspective view of a furniture apparatus 100 having a hinged tabletop 102 and two foldable sections 104 and 106 in a flat horizontal position, in accordance with an embodiment. The furniture apparatus 100 can include a group of height adjustable legs that can be raised or lowered to assist in increasing or lowering a height of the furniture apparatus 100. Although two height adjustable legs 108 and 110 are shown in FIG. 1, it can be appreciated that additional height adjustable legs are located at the other side of the hinged tabletop 102. That is, the embodiment shown can incorporate the use of four height adjustable legs including the height adjustable legs 108 and 110. In one embodiment, the furniture apparatus can be configured as a coffee table, including features such as the sleek, flat hinged tabletop 102 supported by the group of height-adjustable legs.

The furniture apparatus 100 can also include a group of horizontal reinforcing support such as the horizontal reinforcing support 111, which is located between the height adjustable legs 108 and 110 to provide support to the hinged tabletop 102. It should be appreciated that in the configuration shown in FIG. 1, four such horizontal reinforcing supports can be used to provide support to the hinged tabletop 102 and the overall furniture apparatus 100.

FIG. 2 illustrates a side perspective view of the furniture apparatus 100 shown in FIG. 1 with the two foldable sections 104 and 106 in an open position revealing a gap 131 therein, in accordance with an embodiment. The furniture apparatus 100 shown in FIG. 2 thus can include a group of height adjustable legs (e.g., height adjustable legs 108, 110, etc.) supporting the hinged tabletop 102 including the foldable sections 104 and 106, and a group of utility devices that can include one or more utility devices such as utility device 120 and utility devices 133 and 135.

Note that although multiple utility devices 120, 133, and 135 are shown and described herein with respect to the furniture apparatus 100, it should be appreciated that the number of utility devices contained within the gap 131 is not a limiting feature of the embodiments. That is, a single utility device or apparatus may be contained within the gap 131 which and of itself may include more than one utility devices or utility apparatuses or may simply constitute a single utility device. Thus, when referring to a group of utility devices (or a plurality of devices) herein, this feature can include a single utility device or more than one utility device in the context of different embodiments.

The first foldable section 104 and the second foldable section 106 can open upward from a locked and closed position to reveal the gap 131 within the utility devices 120, 133, 135 are installed and concealed when the two foldable sections 104 and 106 are in a closed position and the hinged tabletop 102 rest in the flat horizontal position. The utility device 120 together with the post 122 may form a pillory in some embodiments. In this situation, the first foldable section 104 and/or the second foldable section 106 of the hinged tabletop 102 that conceals the pillory may also be configured as a sliding top. That is, the first foldable section 104 and/or the second foldable section 106 may each function as a sliding top similar to, for example, a roll top desk. Alternatively, the first foldable section 104 and/or the second foldable section 106 can be configured to slide under the hinged table 102 same on the other side, thus revealing the pillory.

Note that the utility device 120 can include two sections 124 and 126, which may connect to one another to form a circular gap 127 within the center of the utility device 120. The utility device 120 can also include a post 122 which can support the utility device 120 in both a closed or horizontal position (e.g., when hidden beneath the hinged tabletop 102 as shown in FIG. 1 and when open in a fully vertical position as shown in FIG. 2). A bracket 45 is also shown in FIG. 1 (and other figures herein) with respect to the bottom of the post 122. Bracket 45 can be implemented as a hinge or rotatable hinge portion that can allow the post 122 to bend angularly with respect to the gap 131. That is, the bracket 45 allows the post to be raised or lowered such that the utility device 120 can be stored within the furniture apparatus 100 horizontally but can be raised into a vertical position as needed. The bracket 45 can function as a rotatable hinge portion that also connects the utility device 120 to other utility devices such as, for example, the utility device 133.

In some embodiments, the utility devices 133 and 135 located within the gap 131 can function as a seat either separately or with one another and may include a group of slats on each such seat. Note that the utility devices 133 and/or 135 may each be configured in some embodiments as flip down seat supports that may drop down or lowered to touch the ground in some situations. Furthermore, in some embodiments the aforementioned seats with the slats may also function as a bench for kneeling or sitting, and the space between the slats can provide further tie down options for participants as well as in attaching some form of padding.

In some embodiments, each height-adjustable leg, the pillory (e.g., utility device 120 and post 122), the first foldable section 104, the second foldable section 106 can be powered. Such an arrangement may include power control knobs with all favorite settings ‘remembered’ or stored in an electronic memory unit, similar to that of, for example, luxury car seat.

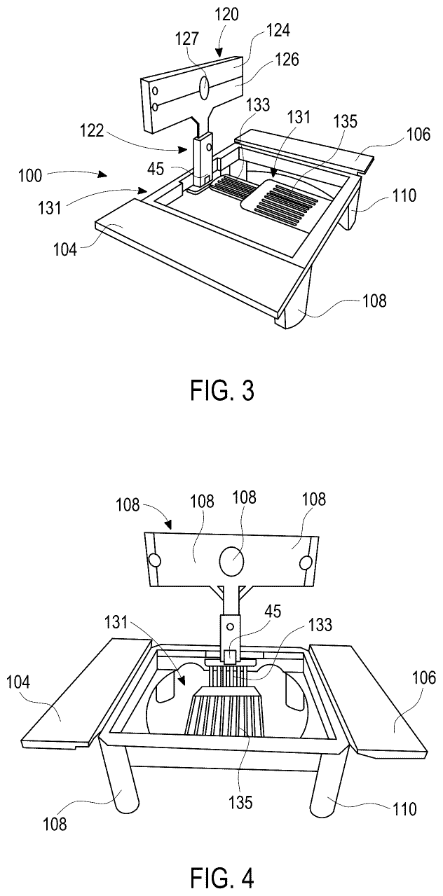

FIG. 3 illustrates another view of the furniture apparatus 100 with one or more utility devices providing a pillory-like structure in an upward position, in accordance with an embodiment. In some embodiments, the utility device 120 may function as a pillory-like structure. That is, a hole is 127 can be formed centrally in the utility device 120 through the connection of the sections 124 and 126 to one another. In addition, as shown more clearly in FIG. 1, utility device 135 is larger than the utility device 133 and connect to one another in a horizontal position within the gap 131.

FIG. 4 illustrates a front view of the furniture apparatus 100 with the utility device 120 in an open and locked position, in accordance with an embodiment. As noted previously, in the figures identical or similar parts or elements are indicated by identical reference numerals. The view shown in FIG. 4 thus shows many of the same elements depicted in FIG. 4, albeit from a different vantage point. Note that the utility device 120 is also height adjustable and can be moved up or down. Thus, the furniture apparatus 100 can be said to offer compound height adjustability via both the legs (up or down) but also the utility device 120 (also, up or down).

As noted previously, the utility device 120 can be implemented as a pillory like structures and the utility devices 133 and 135 can function as a seat or respectively, a wide seat and slightly more narrowly configured seat with each seat having slats formed therein. These utility device 120, 133, and 135 can in some embodiments function as a bondage or BDSM device or a group of such devices. It should be appreciated that utility devices concealed within the furniture apparatus 100 are not limited to bondage/BDSM devices and related implements and can be used to conceal any type of utility device or devices including non-bondage/BDSM devices and implements.

That is, the furniture device 100 can be utilized to maintain and conceal any type of utility device or implement. The furniture apparatus 100 can thus be designed to function as a versatile piece of furniture, such as a coffee table, while concealing an adjustable BDSM bondage device in a discreet and secure manner. This dual-purpose design ensures that the furniture apparatus 100 can seamlessly blend into conventional home decor while offering specialized functionality when needed.

FIG. 4 thus illustrates a front view of the furniture apparatus 100 with the utility device 120 in an open and locked position, providing a clear view of the arrangement and functionality of the various components from this perspective. The utility device 120, when open, reveals a pillory-like structure, which includes the two sections 124 and 126, forming a circular gap 127. This structure is supported by the post 122, ensuring stability whether the device is in a closed, horizontal position or an open, vertical position.

The foldable sections 104 and 106 of the hinged tabletop 102, when opened, create a gap 131, exposing the concealed utility devices 120, 133, and 135. Utility devices 133 and 135, which are larger and smaller seats respectively, include slats and can function either as individual seats or as part of a larger seating arrangement. These utility devices, along with the pillory-like device 120, demonstrate the multifunctionality of the furniture apparatus 100, capable of being used for various purposes, including bondage or BDSM activities, while also being able to conceal any type of utility device or implement. This front view shown in FIG. 4 emphasizes the adaptability and versatility of the furniture apparatus 100, showcasing its potential applications beyond those explicitly mentioned.

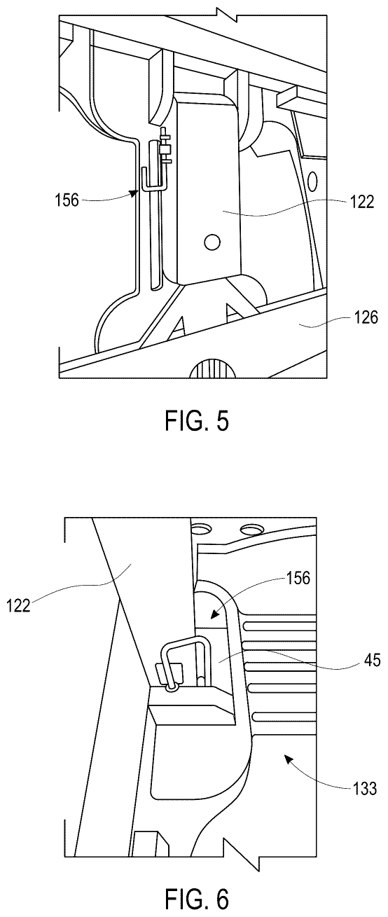

FIG. 5 illustrates a locking mechanism 156, which can be incorporated into the furniture apparatus 100, in accordance with an embodiment. The locking mechanism 156 can be connected to the post 122 and can be used to lock the utility device 120 in its horizontal position. The locking mechanism 156 can also be utilized to lock and secure the utility device 120 when closed and hidden beneath the hinged tabletop 102. In FIG. 5, the section 126 of the utility device 120 is located in a horizontal position and parallel to the ground prior to lifting of the utility device to its upright and open position. The locking mechanism 156 can be configured to slide into, for example, a steel lined insert or a sleeved steel insert in support of the pillar, while also providing in some cases a main skirt reinforcement

FIG. 6 illustrates a side perspective view of the locking mechanism 156 shown in FIG. 5, in accordance with an embodiment. In the view depicted in FIG. 6, the post 122 is shown as upright and supporting the utility device 120 (not shown in FIG. 6), while utility device 133 (the narrower seat) is shown in a horizontal position parallel to the ground.

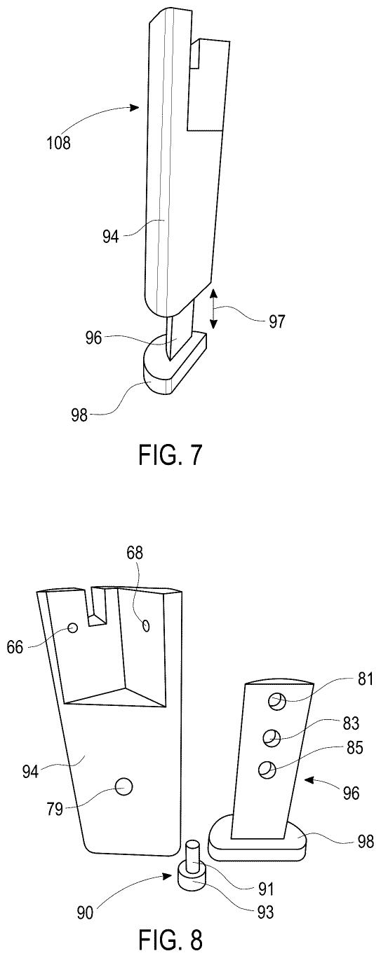

FIG. 7 illustrates the height adjustable leg 108, which may be implemented in accordance with an embodiment. FIG. 7 depicts one height adjustable leg 108 among the four height adjustable legs that support the hinged tabletop 102. The example height adjustable leg 108 can include a riser 94 along with a base 98 and a leg portion 96 upon which the height adjustable leg 108 can move up or down as indicated by the double arrow 97 shown in FIG. 7.

FIG. 8 illustrates a view of individual components of the height adjustable leg 108, which may be implemented in accordance with an embodiment. The height adjustable leg 108 can move up or down as shown by the double arrow 97 depicted in FIG. 7 and may be locked into place at one of a number of positions associated with the circular holes 81, 83, 85 through which a locking pin 90 may be situated. The leg portion 96 can be configured with the the circular holes 81, 83, 85. The pin 90 may fit through a circular hole (such as one of the circular holes 81, 83, 85) to engage with the hole 79 configured within the riser 94 of the height adjustable leg 108. Note that the two holes 66 and 68 located toward the top of the riser 94 can be implemented as threaded collars for removal of legs for transport or shipping of the furniture apparatus 100.

FIG. 8 thus provides for a detailed view of the individual components of the height adjustable leg 108, implemented in accordance with an embodiment. FIG. 8 breaks down the components to illustrate their specific roles in enabling height adjustment. The height adjustable 108 can be designed to move vertically, as indicated by the double arrow 97 in FIG. 7 and can be secured at various heights.

The height adjustable leg 108 relies on a series of circular holes 81, 83, 85, strategically positioned along the leg portion 96. These holes can allow for the insertion of a locking pin 90, which can secure the leg at a desired height. The pin 90, when inserted through one of the circular holes (81, 83, or 85), engages with a corresponding hole 79 within the riser 94 of the leg 108. This engagement ensures that the leg remains stable at the chosen height, providing reliable support for the hinged tabletop 102.

Additionally, FIG. 8 highlights the modular design of the height adjustable leg 108, showing how the components such as the riser 94, base 98, and leg portion 96 interact. The base 98 provides a stable foundation, while the riser 94 and leg portion 96 work in tandem to facilitate the height adjustment mechanism. The precise alignment of the circular holes and the locking pin 90 is important for the secure locking and easy adjustment of the leg height. Note that the locking pin 90 may be implemented in some embodiments as a magnetic locking pin associated with the height adjustable leg 108. FIG. 8 shows the magnetic portion 91 of the locking pin 90 located above a lower portion 93 of the locking pin 90. The magnetic portion 91 may constitute an upper portion of the locking pin 90, which is located above the lower portion 93. It should be appreciated that the furniture apparatus 100 may include a number of magnetic locking pins respectively associated with the height adjustable legs.

Note that the magnetic locking pins may be implemented in some embodiments with neodymium or other rare earth magnets. That is, the magnetic portion 91 of the locking pin 90 as shown in FIG. 8 may be composed of neodymium or other rare earth magnetic material. Neodymium magnets (NdFeB magnets) are composed of an alloy of neodymium, iron, and boron. They are the strongest type of permanent magnets available commercially. Neodymium magnets can produce a strong magnetic field, making them suitable for applications where high magnetic forces are required. They also have a high resistance to demagnetization. Neodymium magnets can also lose their magnetic properties at high temperatures, usually above 80-200° C., depending on the grade. Other examples or rare earth magnets, which can be adapted for use in accordance with various embodiments include Samarium-Cobalt (SmCo) Magnets, Ceramic (Ferrite) Magnets and so on.

In some embodiments, the group of utility devices 120, 133, and 135 may together form an adjustable restraint apparatus. That is, such an adjustable restraint apparatus can comprise the group of utility devices 120, 133, and 135, wherein this adjustable restraint apparatus can be concealed beneath the hinged tabletop 102 when the foldable sections 102 and 104 are located in a closed position to form the hinged tabletop 102. The furniture apparatus 100 itself in a closed position (with the adjustable restraint apparatus hidden therein) may function as, for example, a coffee table including the hinged tabletop 102. When the foldable sections 120 and 104 are open, the adjustable restraint apparatus is revealed. The adjustable restraint apparatus composed of the utility devices 120, 133, and 135 can function in some embodiments as a BDSM bondage device.

It should be appreciated that the furniture apparatus 100 described herein can include other features with or without the aforementioned adjustable restraint apparatus/bondage device. That is, other types of utility devices may be implemented in the context of different embodiments. For example, one potential feature may involve a built-in wireless charging station concealed below or within the hinged tabletop 102, allowing electronic devices to be charged when the tabletop sections 104 and 106 are closed. Another enhancement to the furniture apparatus 100 may be the integration of an integrated lighting system with adjustable brightness levels, activated when the tabletop sections 102 and 104 are opened, providing illumination for various tasks. The adjustable brightness levels may include adjustability through all wavelengths of light within the visible light spectrum.

In some embodiments, further utility features and utility devices can be provided by a power strip with multiple electrical outlets and USB ports, also concealed beneath or within the hinged tabletop 102, which becomes accessible when the sections 102 and 104 are open. To ensure comfort, a built-in cooling fan system may be incorporated with the furniture apparatus 100, providing ventilation when needed. Additionally, the furniture apparatus 100 in some embodiments may be configured to include a built-in sound system with Bluetooth connectivity, enabling users to play audio from their devices.

For productivity, a fold-out laptop stand may be incorporated into the first foldable section 104, adjustable to multiple angles for ergonomic use. Secure storage can be addressed with a concealed compartment featuring a modified locking mechanism, ideal for personal items. An integrated air purifier system with replaceable filters may also be included in some embodiments, activated when the tabletop sections 102 and 104 are open.

The furniture apparatus 100 may also be configured in some embodiments to include concealed drawers with soft-close mechanisms, providing additional storage when the sections 102 and 104 are open. A modular shelf system may also be integrated within or below tabletop 102, which can be expanded or retracted for extra storage options. In some embodiments, the furniture apparatus 10 may also be modified to include options such as cameras used for filming and use by people who are part of the BDSM community to broadcast that the pillory is available use by community members. Storage devices may also be included for data logging and storage and share and/or use by others. Note that because the furniture apparatus 100 is easily transportable, it can be moved to different locations for use by different members of the community.

The furniture apparatus 100 described and illustrated herein presents a highly versatile and multifunctional piece of furniture, embodying a range of innovative features that can enhance both utility and convenience. The furniture apparatus 100 includes height adjustable legs supporting a hinged tabletop with at least two foldable sections. These sections, when opened, reveal the gap 131 that conceals a variety of utility devices, thus maintaining a sleek and unobtrusive appearance when closed.

One of the key features is the integration of one or more locks to secure the hinged tabletop in its closed position, ensuring that the concealed devices remain hidden and the tabletop remains stable. Additionally, the furniture apparatus 100 includes utility devices connected by a rotatable hinge, which allows for the upward rotation and locking of one device at ninety degrees to the other. This configuration offers diverse applications, such as transforming into a pillory/stock and seat arrangement, with the seat constructed from a series of slats with gaps in between.

The height-adjustable legs, equipped with magnetic locking pins, provide flexibility in setting the desired height of the apparatus. This adaptability is particularly beneficial in different usage scenarios, ranging from a coffee table to a workstation. The apparatus also features an adjustable restraint system, which can be cleverly concealed beneath the hinged tabletop and can be revealed when the sections are opened. This system can include configurations suited for various uses, including, but not limited to, BDSM bondage devices.

The furniture apparatus 100 can be designed to seamlessly integrate a multitude of functionalities while maintaining an elegant and discreet appearance. Its innovative design and versatile applications make it a valuable addition to any space, catering to a wide range of user needs and preferences. The combination of adjustable components, secure locking mechanisms, and concealed utility devices highlights the thoughtful engineering and practical ingenuity behind this innovation.

In its primary configuration as a coffee table, the furniture apparatus 100 features a sleek, flat tabletop supported by the height-adjustable legs. The hinged tabletop 102 includes foldable sections 104 and 106 that, when closed, create a smooth and unbroken surface ideal for everyday use. The height-adjustable legs are equipped with magnetic locking pins, allowing the table height to be easily modified to suit various settings and user preferences, from a low coffee table height to a higher level.

An innovative aspect of the furniture apparatus 100 lies in its ability to conceal an adjustable BDSM bondage device. The bondage device is ingeniously installed within the gap 131 created by the foldable sections 104 and 106 of the tabletop. When the sections 104, 106 are in the closed position, the device can be completely hidden from view, maintaining the traditional aesthetic and functionality of the furniture apparatus 100 (e.g., as a coffee table). This concealment can be further secured by one or more locking mechanisms that can ensure the tabletop sections remain firmly closed, preventing accidental opening and ensuring privacy.

Upon unlocking and opening the foldable sections of the tabletop, the hidden gap is revealed, providing access to the adjustable BDSM bondage device. This device includes a variety of components that can be configured to meet specific needs. For instance, it might feature a pillory/stock mechanism and a seat, where the pillory can rotate upward and lock into a position ninety degrees relative to the seat. The seat itself might consist of multiple slats with gaps in between, designed for both comfort and function.

The adjustability of the bondage device is a key feature, allowing for customization to fit the user's requirements. This feature can include adjustable restraints, cuffs, and supports that can be modified for different body types and positions. The discreet nature of the furniture apparatus 100 can ensure that it remains hidden when not in use, transforming the apparatus back into an innocuous piece of furniture with ease.

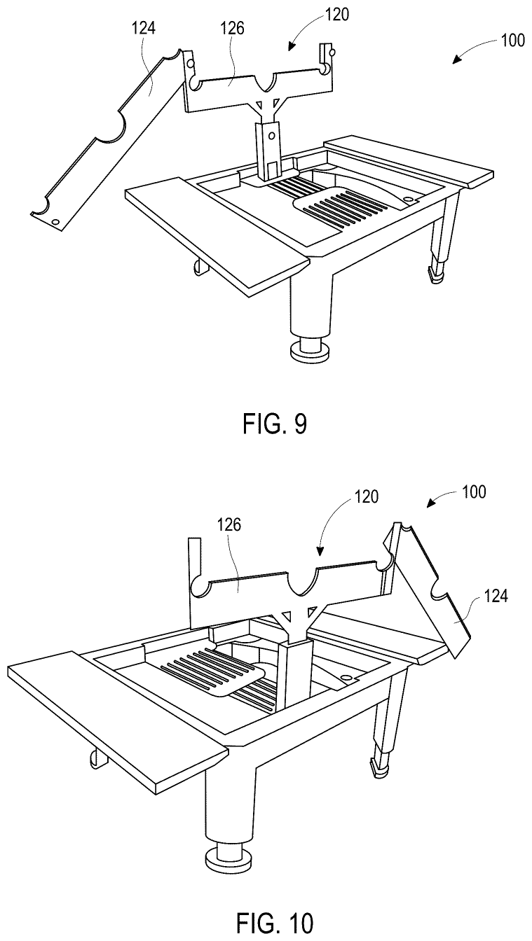

FIG. 9 illustrates a front view of the furniture apparatus 100 with the utility device in an open position, in accordance with an embodiment. Note that in the interest of brevity, each and every previously discussed reference numeral and respective component of the furniture apparatus 100 may not be completely shown or referred to in FIG. 9 and the remaining figures.

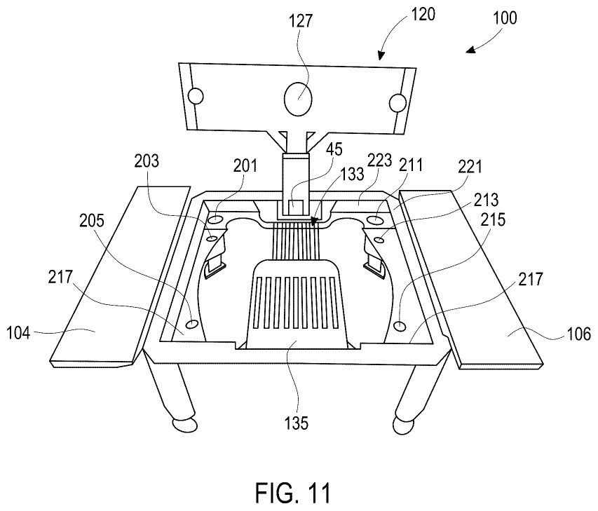

FIG. 10 illustrates a back view of the furniture apparatus 100 with the utility device in the open position, in accordance with an embodiment. The view shown in FIG. 10 is an opposing view of the perspective depicted in FIG. 10.

FIG. 11 illustrates a view of the furniture apparatus 100 with a series of holes located at each corner, which can be used as tie downs for transportation and/or storage of the furniture apparatus, in accordance with an embodiment. The series of holes shown in FIG. 11 include holes 201, 203 located at one corner within the gap 131, along with holes 215, 217 located in the opposite corner. Additionally, the series of holes can include holes 205, 207 located in the corner opposite holes 211, 213. Each hole pair includes a larger hole and a smaller hole with respect to one another, which can function as tie downs for restraint devices. In addition, the view of the furniture apparatus 100 shown in FIG. 11 depicts one or more dowels such as dowel 221, which can secure a handle such as handle 223 that can slide laterally underneath a wing or sliding wing support.

Note that the curved portion between, for example, hole 201 and hole 201 can provide an ergonomic space and support for knees of the participant in, for example, the pillory while sitting. The curved spaces between holes 207 and 217 may also provide ergonomic support and the integration of a lower leg or calf portion of a participant in a standing position. It should be appreciated that embodiments are not limited to a single pillory or a single utility device. For example, in some embodiments, the furniture apparatus 100 may be modified to include a double expanding arrangement with a double pillory station. Alternatively, two pieces may be locked together. Increasing the utility devices in length and weight but not width may provide positions for two participants in some embodiments.

The disclosed furniture apparatus 100 provides for a discreet storage solution that can be integrated into, for example, common household furniture while offering a seamless blend of functionality and style. The solution offered by furniture apparatus 100 is particularly valuable in smaller living spaces where maximizing the use of available space is crucial. By incorporating concealed compartments within everyday furniture items, such as coffee tables, homeowners can maintain an uncluttered and visually pleasing environment while ensuring that essential utility devices are easily accessible yet out of sight.

This approach not only enhances the practical use of furniture but also contributes to a more organized and harmonious living space. Discreet storage within furniture pieces allows for the secure storage of valuable or sensitive items, reducing the risk of theft or damage. Additionally, this helps to maintain a clean and minimalist look, which is increasingly favored in modern interior design trends.

Overall, the integration of concealment chambers within furniture items like coffee tables represents a significant advancement in addressing the dual need for practicality and aesthetic enhancement in home environments. The innovation of furniture apparatus 100 meets the demands of contemporary living by providing elegant solutions for the storage of utility devices, ensuring that homes can remain both functional and beautifully designed.

The necessity for discrete storage solutions extends beyond traditional utility devices to more personal and sensitive items, such as BDSM and bondage devices. With the increasing acceptance and practice of diverse lifestyles, including those involving BDSM, individuals seek ways to incorporate these elements into their living spaces discreetly and respectfully.

The discreet storage solutions integrated into common household furniture provides for a seamless blend of functionality and style. For individuals who practice BDSM, the need for secure, private storage is paramount. These devices require careful consideration regarding both accessibility and privacy. As discussed previously, traditional storage methods, such as visible cabinets or drawers, can compromise the discretion that users often desire, leading to potential discomfort or embarrassment if discovered by guests or other household members.

By incorporating concealed compartments within everyday furniture items, such as coffee tables, homeowners can maintain an uncluttered and visually pleasing environment while ensuring that sensitive items are securely stored and easily accessible. This approach not only enhances the practical use of furniture but also contributes to a more organized and harmonious living space. Discreet storage within furniture pieces allows for the safe storage of BDSM and bondage devices, reducing the risk of accidental discovery or exposure. For example, discreet storage solutions may be necessary to hide such devices from societal busy bodies, along with avoiding cultural and religious pressures.

Furthermore, the integration of concealment chambers for such devices addresses the broader need for privacy and respect for personal lifestyle choices. It ensures that individuals can enjoy their private practices without compromising the aesthetic integrity of their living spaces. Concealment solutions also provide a level of psychological comfort, knowing that personal items are securely hidden from view, which can enhance the overall living experience.

Incorporating discreet storage solutions into household furniture, like coffee tables, represents a significant advancement in addressing the dual need for practicality and aesthetic enhancement in home environments. This innovation meets the demands of contemporary living by providing elegant solutions for the storage of sensitive utility devices, ensuring that homes can remain both functional and beautifully designed while respecting personal privacy and lifestyle choices.

Based on the foregoing, it can be appreciated that a number of embodiments are disclosed herein including preferred and alternative embodiments. In an embodiment, a furniture apparatus can be implemented, which can include: a plurality of height adjustable legs supporting a hinged tabletop comprising at least two foldable sections including a first foldable section and a second foldable section; and a plurality of utility devices, wherein the first foldable section and the second foldable section open upward from a locked and closed position to reveal a gap within which the plurality of utility devices are installed and concealed when the at least two foldable sections are in a closed position and the hinged tabletop rests in a flat horizontal position.

An embodiment can further include at least one lock that can secure the hinged tabletop.

An embodiment may also include at least one lock that can secure the hinged tabletop when the at least two foldable sections are closed and folded flat to form the hinged tabletop and conceal the plurality of utility devices.

In an embodiment, the plurality of utility devices can include a first utility device connected to a second utility device by a rotatable hinge portion.

In an embodiment, the plurality of utility devices can include a first utility device connected to a second utility device by a rotatable hinge portion that can allow the first utility device to rotate upward and lock to a position ninety degrees with respect to the second utility device, which can remain in a horizontal position.

In an embodiment, the first utility device can comprise, for example, a pillory/stock and the second utility device can comprise, for example, at least one seat.

In an embodiment, the at least one seat can include a plurality of slats with gaps respectively located between each slat.

In an embodiment, each leg among the plurality of height adjustable legs can be raised or lowered to assist in increasing or lowering the height of the furniture apparatus from the ground.

An embodiment can further include a plurality of magnetic locking pins respectively associated with the plurality of height adjustable legs.

An embodiment may also include an adjustable restraint apparatus that can comprise the plurality of utility devices, wherein the adjustable restraint apparatus is concealed beneath the hinged tabletop when the at least two foldable sections are located in a closed position to form the hinged tabletop.

An embodiment of the furniture apparatus can be implemented as a coffee table including the hinged tabletop, wherein when the at least two foldable sections are open the adjustable restraint apparatus is revealed.

In an embodiment, the adjustable restraint device can comprise a BDSM bondage device.

In an embodiment, a furniture apparatus, can include: a plurality of height adjustable legs supporting a hinged tabletop comprising at least two foldable sections including a first foldable section and a second foldable section; a plurality of utility devices, wherein the first foldable section and the second foldable section open upward from a locked and closed position to reveal a gap within which the plurality of utility devices are installed and concealed when the at least two foldable sections are in a closed position and the hinged tabletop rests in a flat horizontal position; and at least one lock that secures the hinged tabletop when the at least two foldable sections are closed and folded flat to form the hinged tabletop and conceal the plurality of utility devices.

In an embodiment, a furniture apparatus, can include: a plurality of height adjustable legs supporting a hinged tabletop comprising at least two foldable sections including a first foldable section and a second foldable section; at least one utility device, wherein the first foldable section and the second foldable section open upward from a locked and closed position to reveal a gap within which the plurality of utility devices are installed and concealed when the at least two foldable sections are in a closed position and the hinged tabletop rests in a flat horizontal position; and at least one lock that secures the hinged tabletop when the at least two foldable sections are closed and folded flat to form the hinged tabletop and conceal the at least one utility device, wherein the at least one utility device includes a first utility device connected to a second utility device by a rotatable hinge portion that allows the first utility device to rotate upward and lock to a position ninety degrees with respect to the second utility device, which remains in a horizontal position.

It will be appreciated that variations of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which are also intended to be encompassed by the following claims.

What is claimed is:

1. A furniture apparatus, comprising:
a plurality of height adjustable legs supporting a hinged tabletop comprising at least two foldable sections including a first foldable section and a second foldable section; and
a plurality of utility devices, wherein the first foldable section and the second foldable section open upward from a locked and closed position to reveal a gap within which the plurality of utility devices are installed and concealed when the at least two foldable sections are in a closed position and the hinged tabletop rests in a flat horizontal position.

2. The furniture apparatus of claim 1 further comprising at least one lock that secures the hinged tabletop.

3. The furniture apparatus of claim 1 further comprising at least one lock that secures the hinged tabletop when the at least two foldable sections are closed and folded flat to form the hinged tabletop and conceal the plurality of utility devices.

4. The furniture apparatus of claim 1 wherein the plurality of utility devices includes a first utility device connected to a second utility device by a rotatable hinge portion.

5. The furniture apparatus of claim 1 wherein the plurality of utility devices includes a first utility device connected to a second utility device by a rotatable hinge portion that allows the first utility device to rotate upward and lock to a position ninety degrees with respect to the second utility device, which remains in a horizontal position.

6. The furniture apparatus of claim 5 wherein the first utility device comprises a pillory/stock and the second utility device comprises at least one seat.

7. The furniture apparatus of claim 6 wherein the at least one seat comprises a plurality of slats with gaps respectively located between each slat.

8. The furniture apparatus of claim 1 wherein each leg among the plurality of height adjustable legs is raised or lowered to assist in increasing or lowering a height of the furniture apparatus.

9. The furniture apparatus of claim 7 further comprising a plurality of magnetic locking pins respectively associated with the plurality of height adjustable legs.

10. The furniture apparatus of claim 1 further comprising an adjustable restraint apparatus comprising the plurality of utility devices, wherein the adjustable restraint apparatus is concealed beneath the hinged tabletop when the at least two foldable sections are located in a closed position to form the hinged tabletop.

11. The furniture apparatus of claim 10 comprising a coffee table including the hinged tabletop, wherein when the at least two foldable sections are open the adjustable restraint apparatus is revealed.

12. The apparatus of claim 10 wherein the adjustable restraint device comprises a BDSM bondage device.

13. A furniture apparatus, comprising:
a plurality of height adjustable legs supporting a hinged tabletop comprising at least two foldable sections including a first foldable section and a second foldable section;
a plurality of utility devices, wherein the first foldable section and the second foldable section open upward from a locked and closed position to reveal a gap within which the plurality of utility devices are installed and concealed when the at least two foldable sections are in a closed position and the hinged tabletop rests in a flat horizontal position; and
at least one lock that secures the hinged tabletop when the at least two foldable sections are closed and folded flat to form the hinged tabletop and conceal the plurality of utility devices.

14. The furniture apparatus of claim 13 wherein the plurality of utility devices includes a first utility device connected to a second utility device by a rotatable hinge portion that allows the first utility device to rotate upward and lock to a position ninety degrees with respect to the second utility device, which remains in a horizontal position.

15. The furniture apparatus of claim 13 wherein:
the first utility device comprises a pillory/stock and the second utility device comprises at least one seat; and
the at least one seat comprises a plurality of slats with gaps respectively located between each slat.

16. The furniture apparatus of claim 13 wherein each leg among the plurality of height adjustable legs is raised or lowered to assist in increasing or lowering a height of the furniture apparatus.

17. The furniture apparatus of claim 13 further comprising an adjustable restraint apparatus comprising the plurality of utility devices, wherein the adjustable restraint apparatus is concealed beneath the hinged tabletop when the at least two foldable sections are located in a closed position to form the hinged tabletop.

18. The furniture apparatus of claim 17 comprising a coffee table including the hinged tabletop, wherein when the at least two foldable sections are open the adjustable restraint apparatus is revealed.

19. The apparatus of claim 17 wherein the adjustable restraint device comprises a BDSM bondage device.

20. A furniture apparatus, comprising:
a plurality of height adjustable legs supporting a hinged tabletop comprising at least two foldable sections including a first foldable section and a second foldable section;
at least one utility device, wherein the first foldable section and the second foldable section open upward from a locked and closed position to reveal a gap within which the plurality of utility devices are installed and concealed when the at least two foldable sections are in a closed position and the hinged tabletop rests in a flat horizontal position; and
at least one lock that secures the hinged tabletop when the at least two foldable sections are closed and folded flat to form the hinged tabletop and conceal the at least one utility device, wherein the at least one utility device includes a first utility device connected to a second utility device by a rotatable hinge portion that allows the first utility device to rotate upward and lock to a position ninety degrees with respect to the second utility device, which remains in a horizontal position.
